(19) United States
(12) Patent Application Publication
(10) Pub. No.: US 2023/0066602 A1
(43) Pub. Date: Mar. 2, 2023

(54) AUTOMATED TELESCOPIC WATER CANNON, WITH WATER TANK CONNECTION CAPABILITY, AUTOMATED WATER GUN

(71) Applicant: Luther C. Trawick, Springfield, VA (US)

(72) Inventor: Luther C. Trawick, Springfield, VA (US)

(73) Assignee: Luther C. Trawick, (omitted)

(21) Appl. No.: 17/461,525

(22) Filed: Aug. 30, 2021

(51) Int. Cl. A62C 25/00; A62C 13/78; A62C 3/02

(52) U.S. Cl. CPC A62C 25/00; A62C 3/0292; A62C 13/78; A62C 99/0072

(57) ABSTRACT

An automated telescopic water cannon and nozzle gun apparatuses that function by variable water pressure controlled by actuator and gear motor. Water pressure extends the water cannon nesting tubes and distance is restrained by center tube retainer cap connected to a winch cable. The water cannon handle bars are positioned for balancing allowing the firefighter to control the apparatus when tubes are extended and the winch reversed pulls the tubes back to the home position.. The bipod elevates, lowers, extends and retracts with actuators for positioning of the apparatus. The external tube has a an attachable polycarbonate heat and blast resistant shied connect at the end. The apparatus connected to the water tank may be transported by a helicopter to fight all types of fires, for an aerial attack. The water nozzle gun has an extended tube stock connection for control assistants and nozzle extension for direct and angle application.

This patent application did not receive any federal research and development funding.

### FIELD OF THE INVENTION

This invention is generally directed to the firefighting apparatuses that are used to suffocate or eliminate all types of fires in the fire fighters field of application.

### BACKGROUND OF THE INVENTION

This invention relates generally to firefighting handheld nozzles, water cannons, automated or non-automated that may be utilized in firefighting, by first responders and firefighters. More specifically the multifunctional inventions relates to a machine that may be controlled with electronics, switches, gear motors, and actuators. Firefighters generally use manual operating hand held nozzles with multiple spray patterns to fight fires that put them in harm’s way to be effective which exposes them to radiant heat, explosions and collapse building. As a result this causes many deaths and severe injuries and reduction of qualified experience first responders. The previous apparatuses in use cannot quickly eliminate fires due to that they are not capable to put the most efficient water patent in close proximity or into the core of the fire to quick elimination which in effect causes sever water damage to property. First responders and casualties are sometimes are abandoned in structural fires due to not having an apparatus with the capability to clear the way for rescue without putting other first responders in harm’s way.

### BRIEF SUMMARY OF THE INVENTION

The invention is an automated electromechanical telescopic water cannon, automated water gun, and water tanker that work in tandem with interchangeable components. This multifunctional apparatuses are rechargeable DC powered and were design to give firefighters the capabilities to fight fires with innovate technology that will keep them out of harm’s way. It may allow the firefighters to reach places that the existing firefighting water nozzles and water cannons cannot reach to extinguish or suppress fires due to its telescoping rotating 90 angle extension tube with IR camera monitor capabilities. The automated telescopic water cannon and gun is designed for one or two man operation which is supported by a shoulder harness for the firefighters which allows a quick removal out of harm’s way in emergency such as, tubes stuck while extended under falling debris or collapsed buildings. The automated telescopic water cannon, water gun maintain a safe distance and protection with attachable polycarbonate heat and blast resistant shied keeping the Firefighters out of harm’s way from radiant heat, and explosions. Many types of off the shelf water heads can be connect to the electromechanical telescopic water cannon, water gun and water tanker as to mission specific requirements. The Electromechanical telescopic water cannon is balanced by having the left front and right rear handle bars placement in the right ergonomic position along with the shoulder harness to allow the firefighter to apply maximum amount of force using less energy as to the seesaw effect rotation, as to pulling up the front handlebar and pushing down on the rear handlebar simultaneously balancing the water gun while in the home positon or fully extended. The automated telescopic water cannon will be incorporated with an bipod with wheels for balance and for transportation. The automated telescopic water cannon is powered with DC rechargeable batteries which power the motors and actuator’s controlled with rotary switches and speed controllers to control the motions and functions of the automated telescopic water cannon. The automated telescopic water cannon is connected to a water tanker that is transported by a helicopter to fight forest fires, ship fires, land and sea oil refineries, and high-rise building that need an aerial attack. It would be controlled remotely by operators in the helicopter with joysticks, video monitors and IR camera to see though smoke and fire. It will rotate to the vertical position with gear motors and actuators putting it in the position to telescope down to the top of trees and the ground to eliminate fires. The electromechanical telescopic water cannon and gun nozzles and connectors are interchangeable as for mission specific operations.

### BRIEF DESCRIPTION OF THE DRAWINGS

FIG. 1A is a perspective view of the invention.

FIG. 1B is a side view of the invention.

FIG. 1C is an side perspective view of a further embodiment of the invention.

FIG. 1D is an top view of the invention.

FIG. 2A is a side travel view of further embodiment the invention.

FIG. 2B is a top travel view of further embodiment the invention.

FIG. 3A is a rear view of further embodiment the invention.

FIG. 3B is a rear perspective view of the self-propelled wheel drive assembly.

FIG. 3C is a perspective view of the self-propelled wheel drive with disk brake assembly.

FIG. 3D is a top view of the throttle control and brake handle of self-propelled concept.

FIG. 4 is a perspective view telescoping tubes of the invention.

FIG. 5 is a view of polycarbonate shied connected to outer tube collar.

FIG. 6A is a top view of the power box and winch control box.

FIG. 6B is a perspective view of the power box and actuator control Box.

FIG. 7A is a perspective view of the bipod assemble.

FIG. 7B is a right angel view of the bipod assemble.

FIG. 7C is a right rear view of the upper bipod assemble.

FIG. 7D is a left rear view of the upper bipod assemble.

FIG. 7E is a right rear perspective view of the upper bipod assemble.

FIG. 8 is a top view of the control box.

FIG. 9 is a perspective view of the gear motor assemble and spool.

FIG. 10A is a right angle view of spool assemble with eyebolt cable guide.

FIG. 10B is a front view of retainer cap with eyebolt cable connection.

FIG. 10C is a right angle view of the stop bar.

FIG. 11 is a bottom angle view of cable guide tube and backflow preventer.

FIG. 12 is perspective view of telescoping tubes inserted.

FIG. 13 is a perspective view of telescoping tube in sequenced alinement along with retainer cap and nozzle connection.

FIG. 14A is a top view of 90 degree tube with Omni directional rotating nozzle.

FIG. 14B is a front view of the Omni directional rotating nozzle.

FIG. 14C is a view of the rotating 360 degree connector parts for the 90 degree tube rotation.

FIG. 14D is a top view of omni directional rotating nozzle parts.

FIG. 14E is a perspective view of nozzle parts in sequence order of assemble from right to left.

FIG. 15A is a side view of the automated water gun nozzle with extended tubes attached.

FIG. 15B is a top angle view of the automated water gun nozzle with extended tube connected to 90 degree angle tube.

FIG. 15C is a perspective view of automated water gun nozzle.

FIG. 15D is a front angle view of automated water gun nozzle control handle.

FIG. 15E is a front view of the water gun nozzle drive motor cover and assemble.

FIG. 15F is a side view of the water gun nozzle rear tube and hose adapter.

FIG. 15G is a perspective view of the water gun nozzle front tube shield attachment bracket, front tube handle bracket and camera monitor assemble.

FIG. 16A is a front view of air lift water tanker.

FIG. 16B is a perspective view of the air water tanker.

FIG. 17 is a top view of the telescoping water cannon rotation assemble attached to the air water tanker.

FIG. 18 is a front view of the inlet port assemble and water pumps.

FIG. 19 is a front view of the water pump and water exit tube and hose connector.

### DETAILED DESCRIPTION OF THE INVENTION

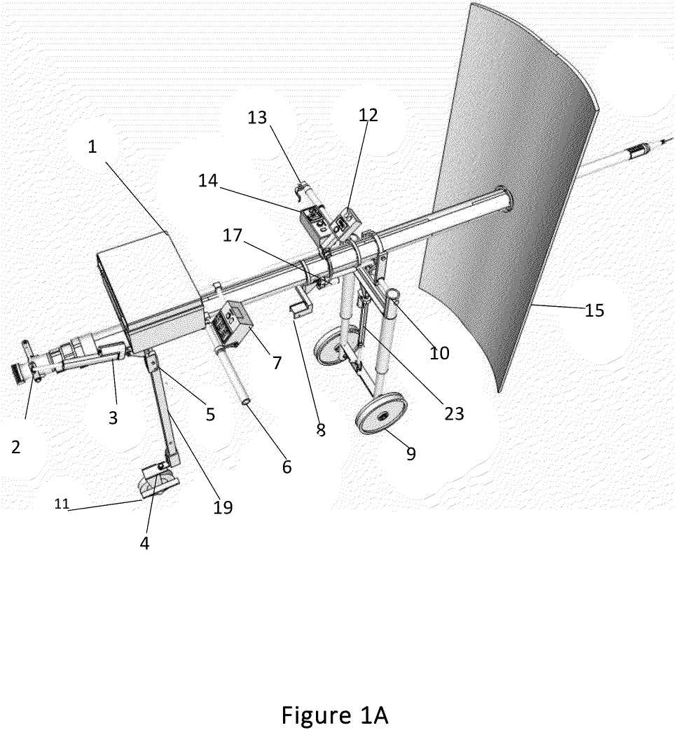

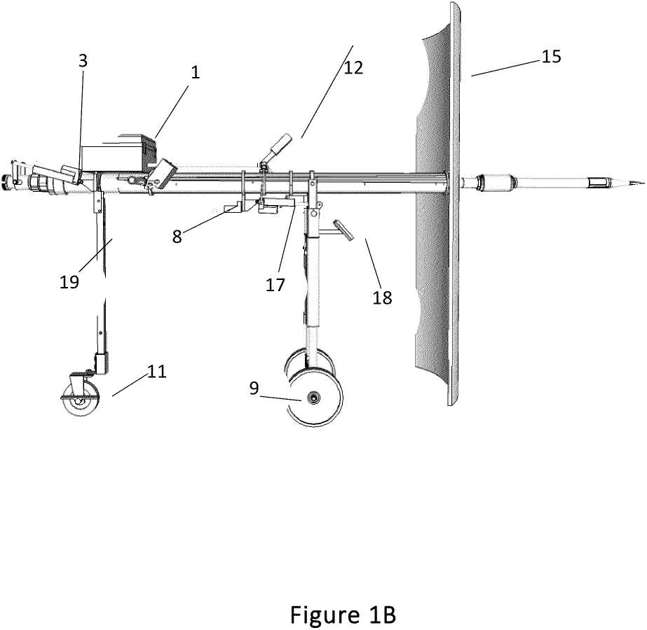

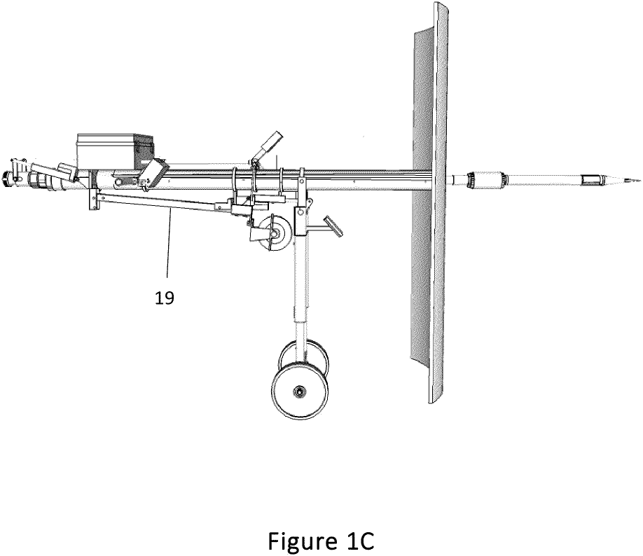

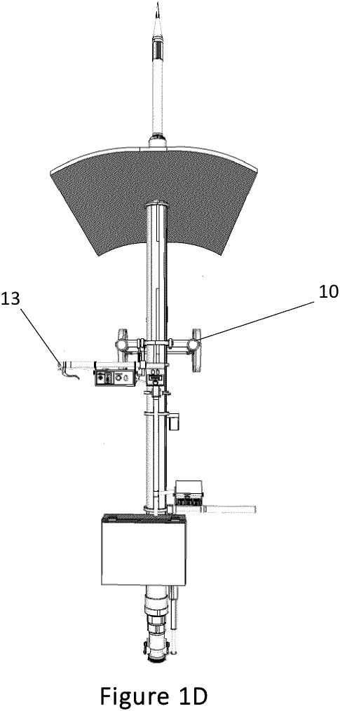

As can be seen in FIGS. 1-19, the invention comprise a telescoping automated water cannon, automated water gun, nozzles, tube extension 90 degrees and remote controlled air water tank incorporated with two telescoping automated water cannons. These apparatuses having interchangeable components and Infrared video monitor system also may be incorporated with off the shelf nozzles for mission specific applications.

FIG. 1A Is a perspective view of the electromechanical telescoping water cannon which displays all the major assemblies. The control box 1 incorporates the DC power source, winch spool assemble, gear motor and wiring power distribution control panel. Inlet valve bracket 2 linked to the actuator 3 rotates the inlet valve to the open and close position. The rear wheel assemble arm 19 connects to the hinge bracket locking 5 for vertical support, travel with the wheel assemble bracket 4 and locking hinge 11 for stability. Power control box 12 distributes power from the control box 1 throughout the apparatus and depicts the power on off switch, battery monitor and lighting switch. The left front handle bar with bipod locking and release handle mechanism 13 is to kept the bipod in the vertical position until released to allow rotation. The control box 14 depicts a switch for forward and reverse and speed control knob. Actuator control box 7 attached to the right rear handle bar depicts three rocker switches for the extension and retraction of actuators 3, 17, 23. Wheels 9 are connected to the bipod assemble 10 for support and transporting the apparatus. The polycarbonate shield 15 attached to the apparatus is to repel extreme heat and explosion.

FIG. 1B is a side perspective view of the automated electromechanical telescoping water cannon rear wheel assemble arm 19 in the vertical position supporting the apparatus in the standalone position.

FIG. 1C is an side perspective view of a further embodiment of the Invention depicting the rear wheel assemble arm 19 in the horizontal position connected to the home positioning bracket 8.

FIG. 1D is an top view of the invention.

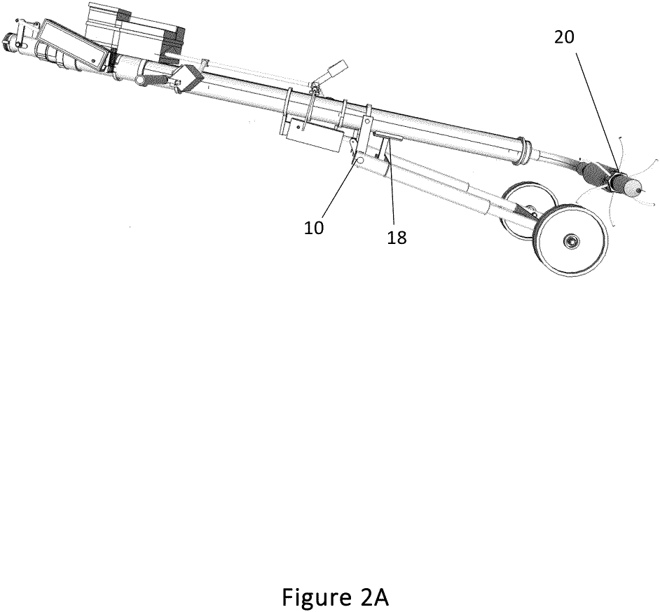

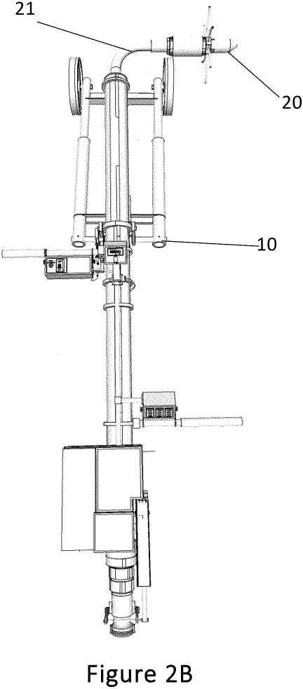

FIG. 2A is a side view of the electromechanical telescoping water cannon in the dolly travel position which displays 18, bipod tube support bar and plate, 21 ,90 degree tube extension with 20, Omni directional oscillating nozzle.

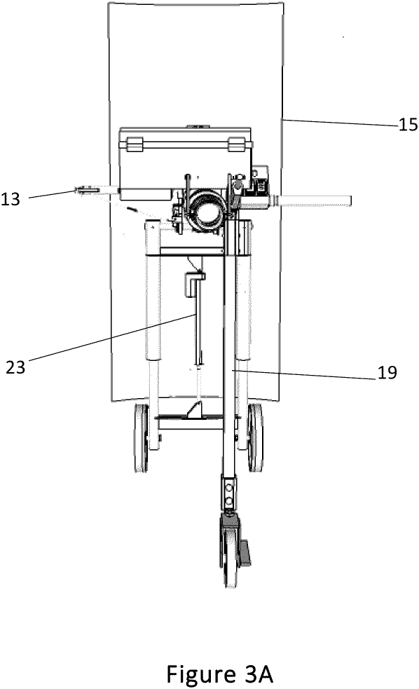

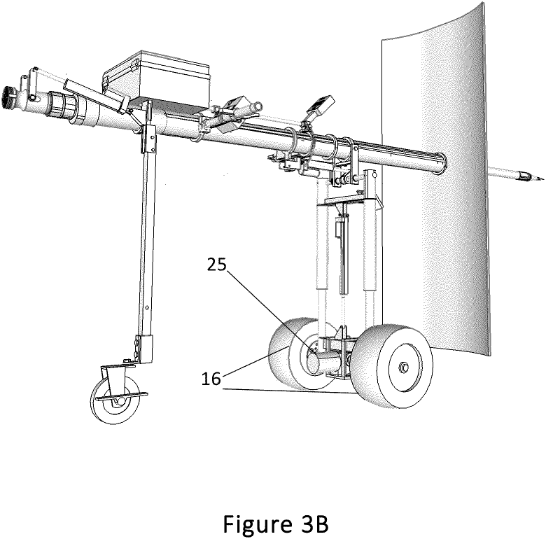

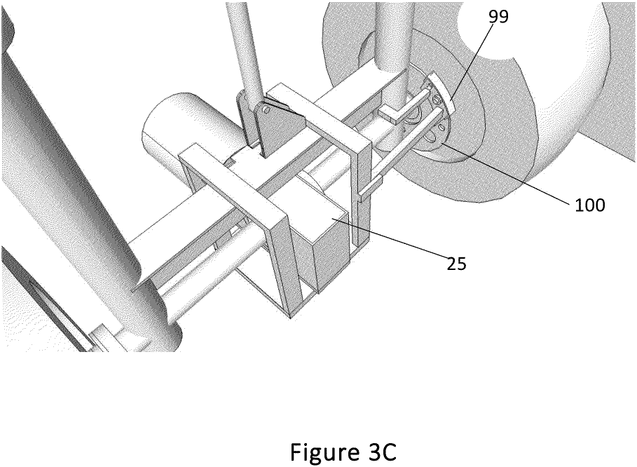

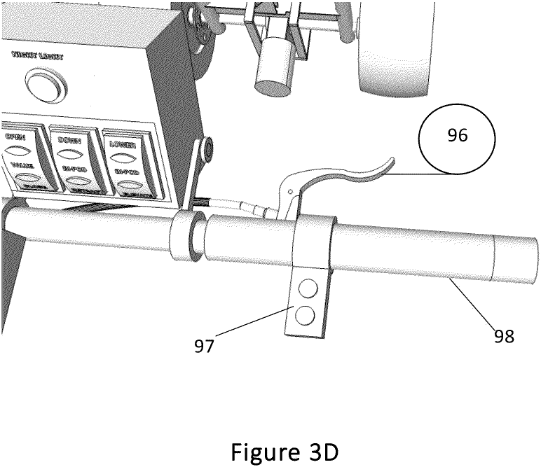

FIG. 3A is a rear view of further embodiment the invention.

FIG. 3B, show views of the self-propelled, 16 all-terrain wheel assembly with, 25 dual axis wheel drive gear motor.

FIG. 3C is a perspective view other of the throttle control and brake handle of self-propelled concept assemble, 25 dual axis, gear motor, 99 rotor disk caliber, 100 disk rotor.

FIG. 3D is a top view of the self-propelled control assemble, 98 hand throttle control, 96 brake handle, and 97 forward and reverse buttons.

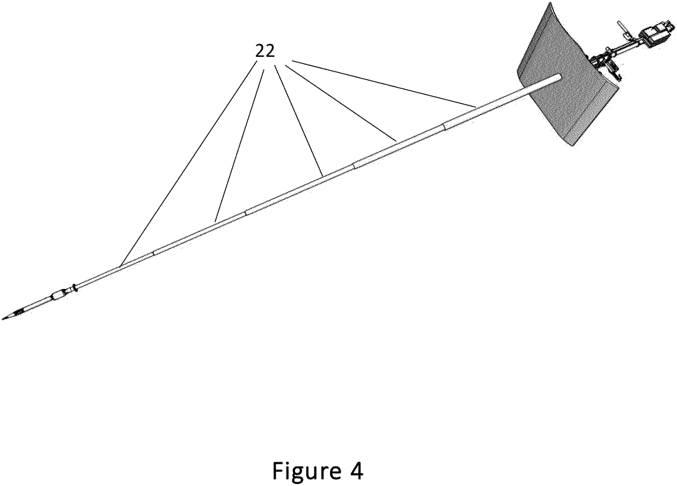

FIG. 4 is a perspective view of the telescopic water cannon with, 24 tubes extended and locked in sequential order at maximum distance.

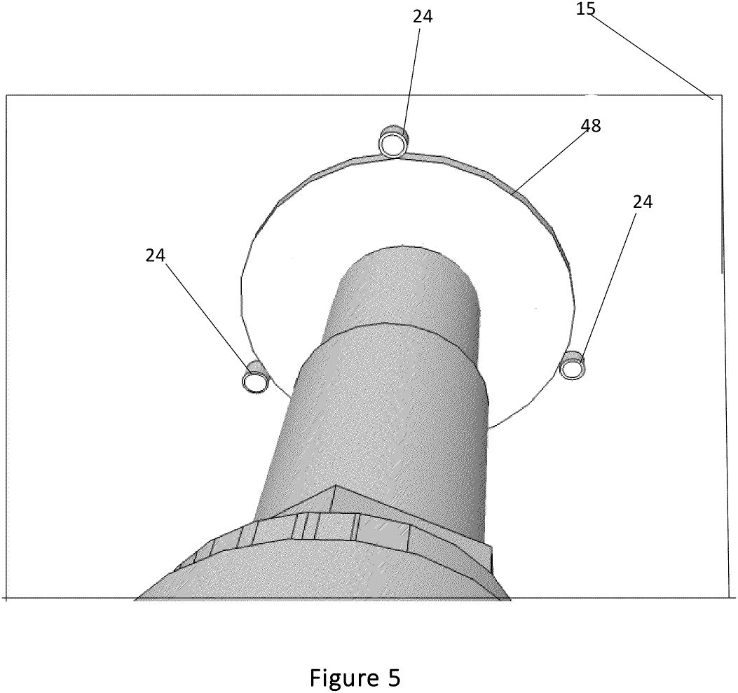

FIG. 5 is a front view of, 15 polycarbonate shield connect to the, 48 tube retainer cap with (3) 24 locking knobs.

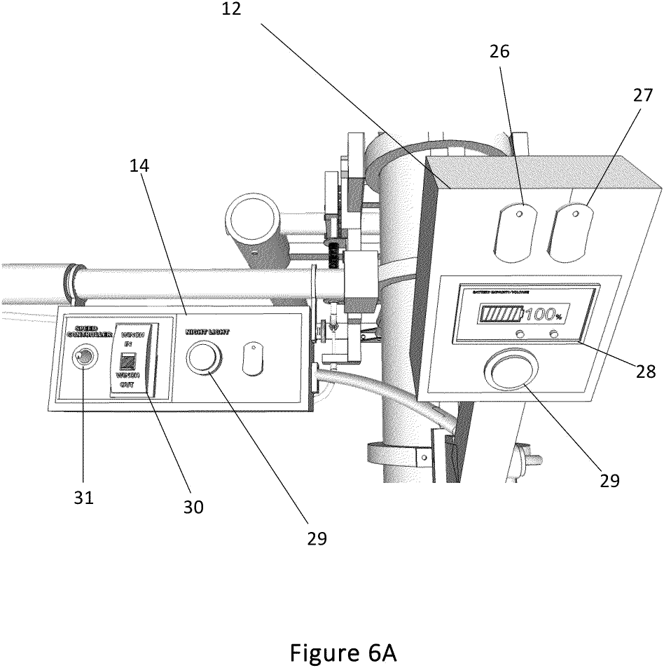

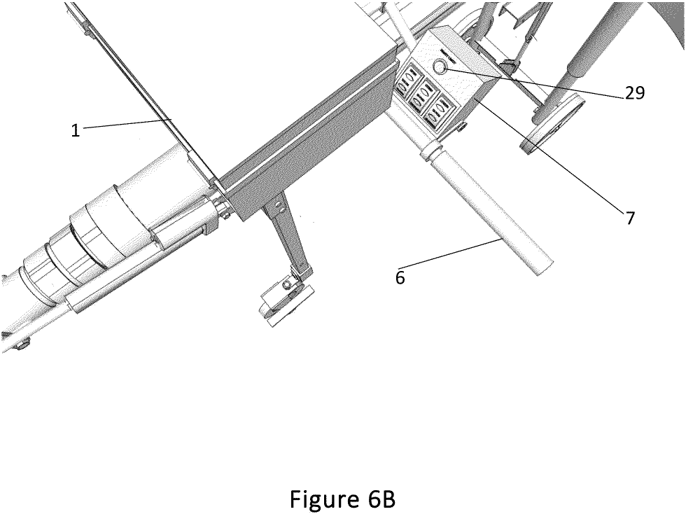

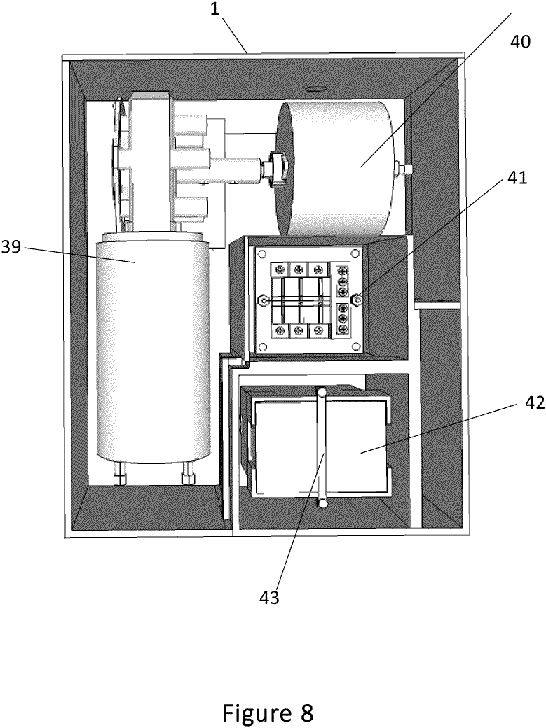

FIG. 6A is a top view of the power box and spool control box. The power control box depicts, 27 system power switch which when activated send power to FIGS. 8, 41 wiring distribution block. Also it will show, 28 battery monitor, system led light switch, and 29 power box illumination led light. The spool control box 14 depicts, 31 variable speed spool control knob, spool directional rocker switch and, 29 power box illumination led light.

FIG. 6B displays a close up view of number points indicated and described in FIG. 1. Actuator control box 7 attached to the right rear handle bar depicts three rocker switches for the extension and retraction of actuators 3, 17, 23.

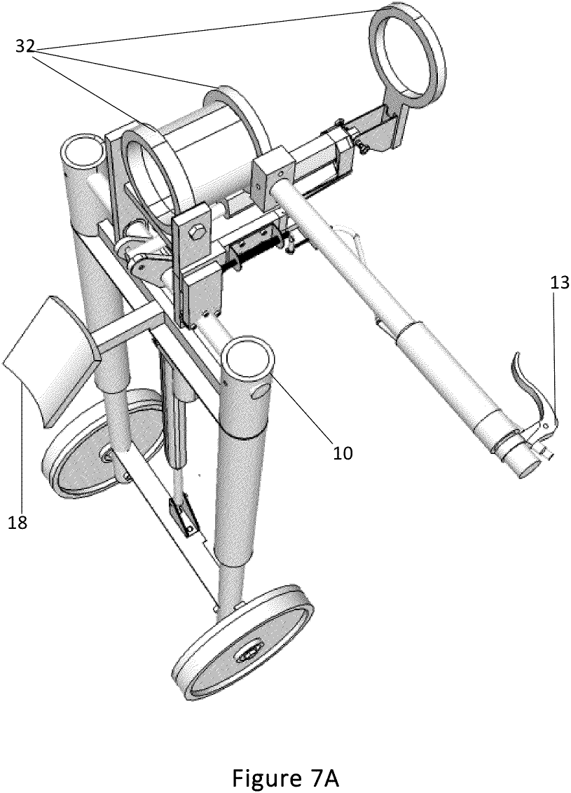

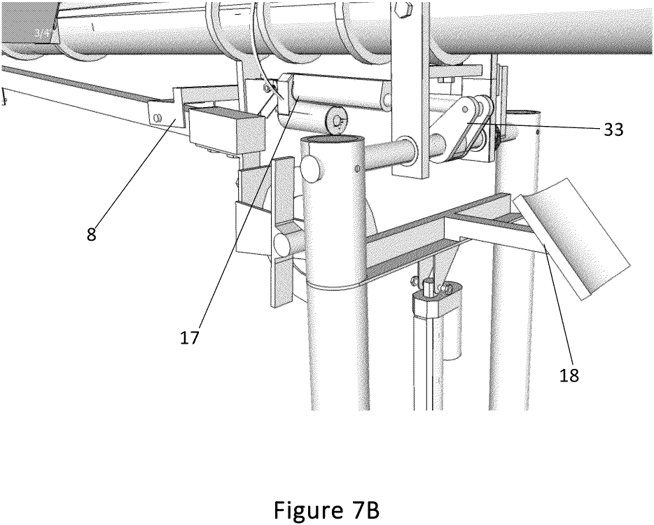

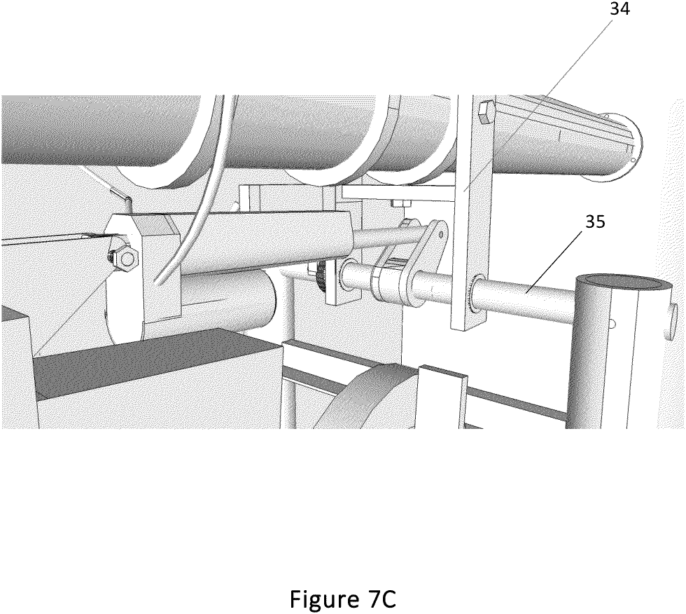

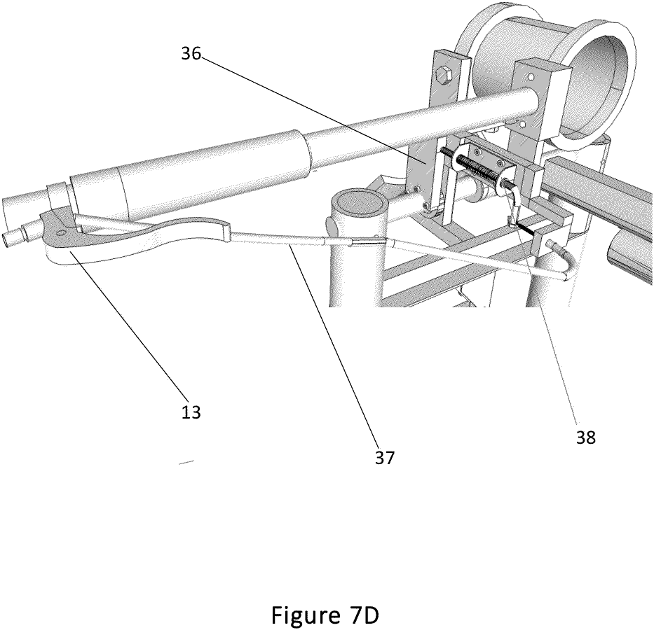

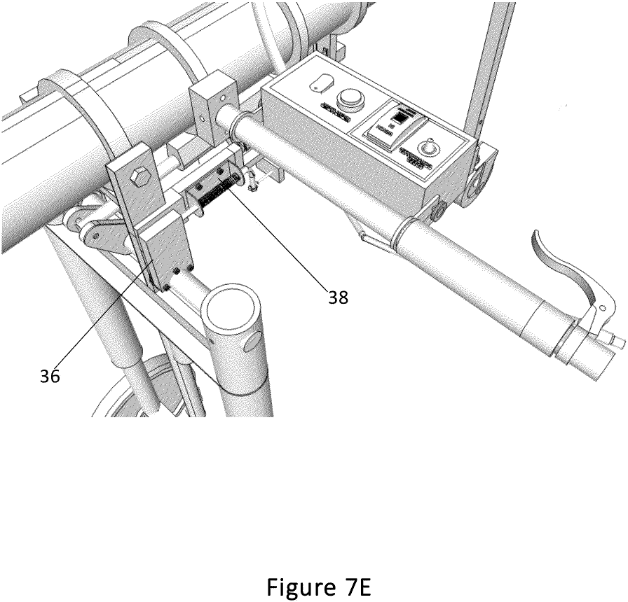

FIG. 7A is a perspective view of the bipod assemble that depicts, 18 bipod support bar and plate which supports the tubes when the telescopic water cannon is in the dolly travel position or when applying water to basement widows or when lower water application is needed. Bipod assemble 10 support the apparatus in travel and rotates forward and reverse, up and down for positioning as needed by the firefighters. Left front pull locking handle 13 is lock and unlock the bipod assemble in the vertical position. to control the leveling and direction of the telescoping water cannon. The tube collars are to maintain the position and placement of the external tube which houses the internal nesting tubes.

FIG. 7B is a right angel view of the bipod assemble which shows, 33 bipod clevis linkage that rotate the bipod forward and reverse when activated by, 17 bipod rotation actuator. Home position bracket 8 holds the rear support wheel assemble when it’s in the horizontal travel position.

FIG. 7C is a right rear view of the upper bipod assemble that depicts, 34 bipod tube attachment bracket assemble that attaches to tube collar, for bipod rotation on, 35 rotation support rod of the bipod assemble.

FIG. 7D is a left rear view of the upper bipod assemble that depicts, 36 locking bar that’s connected to FIGS. 7C, 35 rotation support rod to keep bipod in vertical position until, 38 spring loaded locking rod is retracted and releases the bipod for rotation. This is accomplished when, 13 locking handle collapses retracting 37 cable that is attached the locking rod 38.

FIG. 7E is a right rear perspective view of the upper bipod assemble with same description as FIG. 7D.

FIG. 8 is a top view of the control box which shows, 39 gear motor that drives the spool cable assemble 40. Also included is the wiring distribution block 41, and the DC battery in battery box 42.

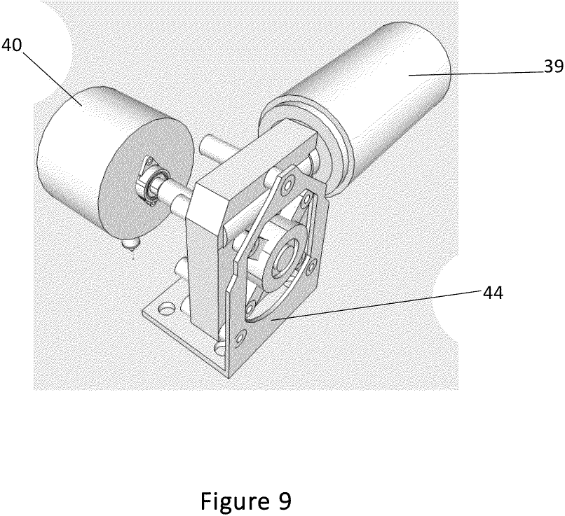

FIG. 9 is a perspective view of the gear motor 39 attached the motor mount 44 and cable spool 40.

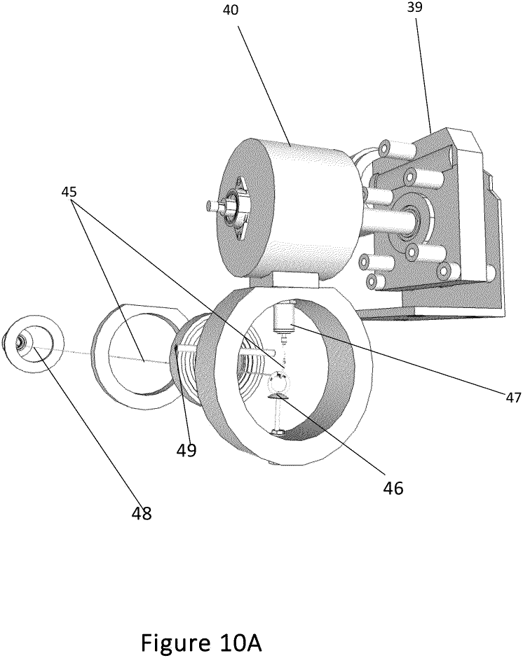

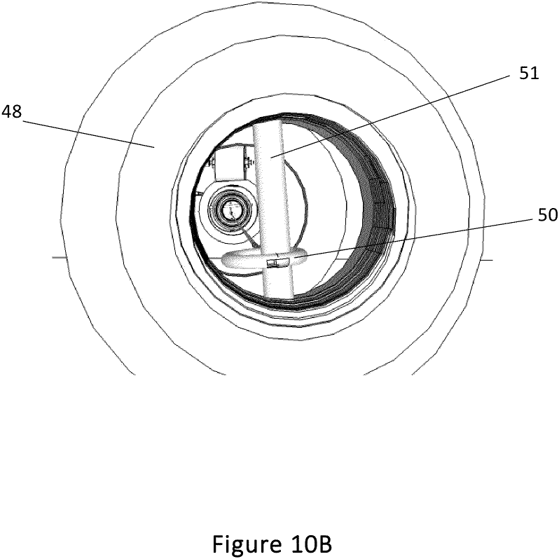

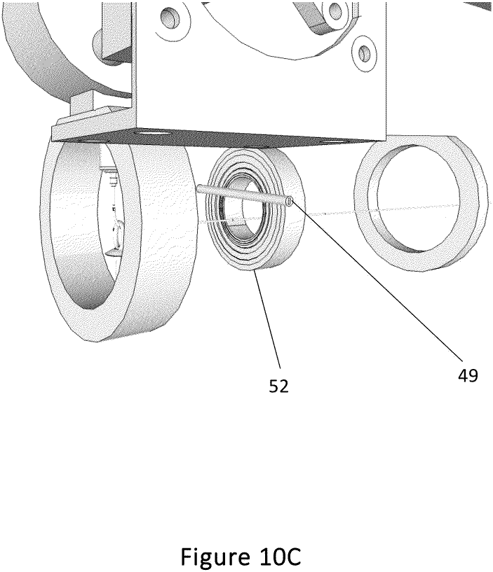

FIG. 10A is a right angle view of spool assemble depicting 47 cable guide water backflow preventer that prevents water from back flowing into, 40 the spool cable assemble and control box, 1. Eyebolt cable guide guides the spool cable 45 alignment to keeps it in the center of the tubes for retraction and extension of the telescoping tubes. The end of the cable is attached to, 50 eyebolt which is attached to, 51 retainer cap center rod in the retainer cap assemble 48, to hold tubes in place, release for extension, retraction to, 49 telescoping tubes stop bar.

FIG. 10B is a front view of retainer cap with eyebolt cable connection with description and function as in FIG. figurer10A.

FIG. 10C is a right angle view of the stop bar 49 in place keeping the tubes evenly nested in the simulated tube view when retracted.

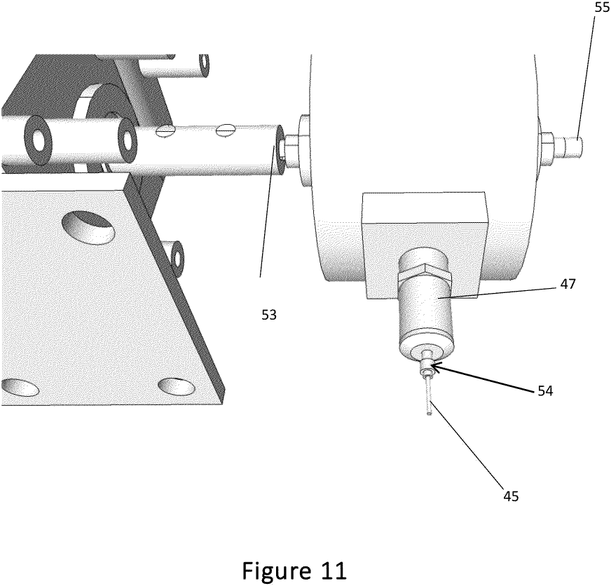

FIG. 11 is a bottom angle view of cable guide tube backflow Preventer 47, 40 spool cable assemble with spool shaft 55 connected to 53, gear motor shaft connector for rotation of the cable spool. The backflow preventer 47 depicts, 54 backflow cable guide extension with cable 45 inserted.

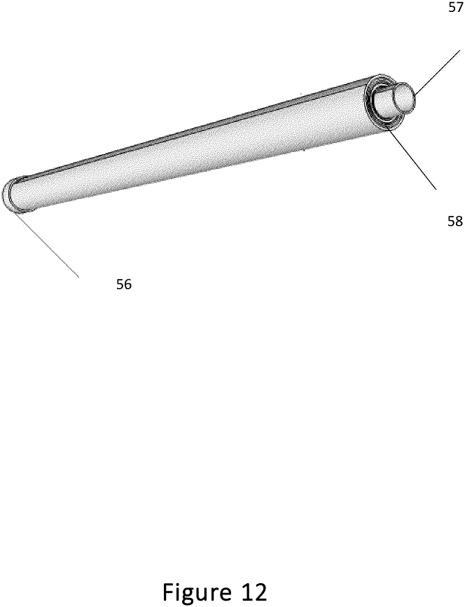

FIG. 12 is perspective view of telescoping tubes inserted and nesting 58, with center tube 57 extended length to connect the retainer cap 48. At the end 57, is 56, delrin piston that guides the nesting tubes for smooth and leak-proof transition when retracting or extending.

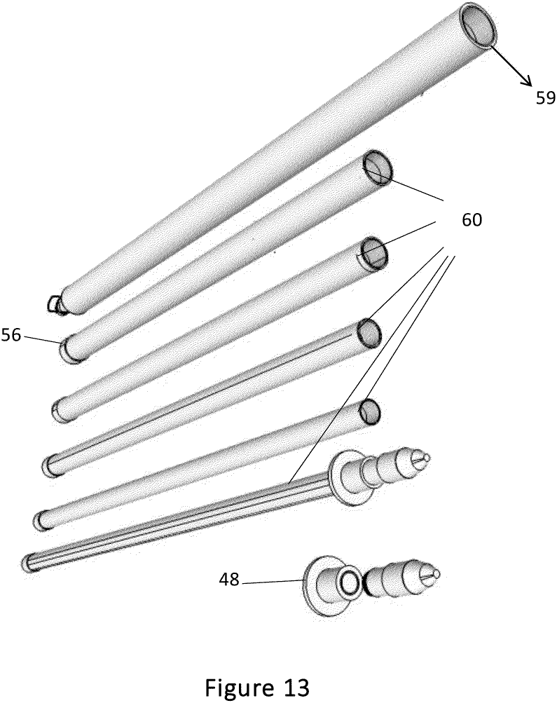

FIG. 13 is a perspective view of telescoping tube in sequenced alinement along with retainer cap and nozzle connection which depicts the external tube 59 with delrin sleeve to stop next sequencing tube when fully extended. The five sequencing tube have delrin sleeves 60 to block external delrin pistons 56 when fully extending. Retainer cap assemble 48 is shown connected to the center tube with nozzle.

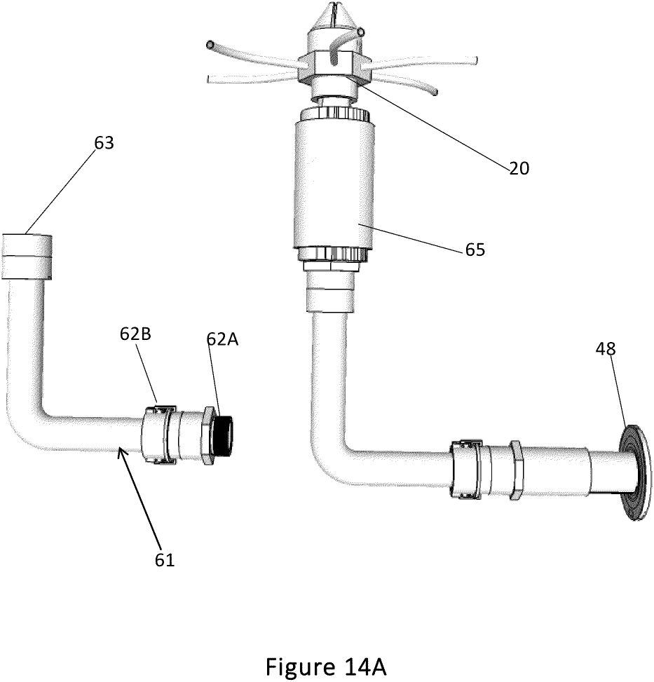

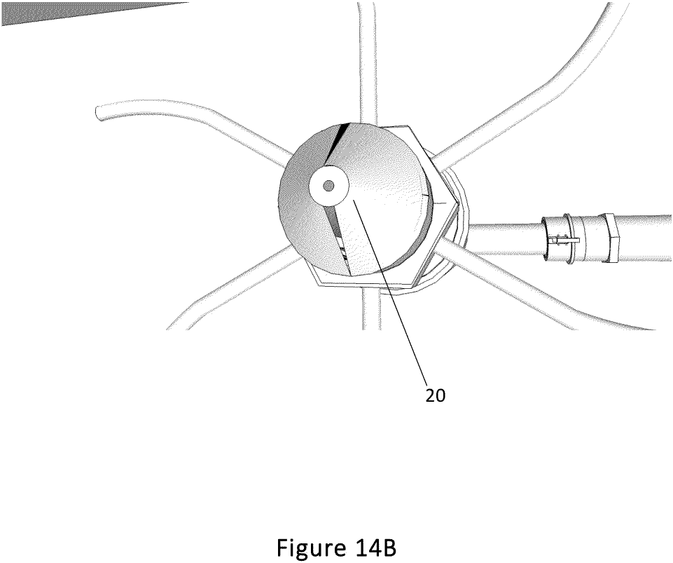

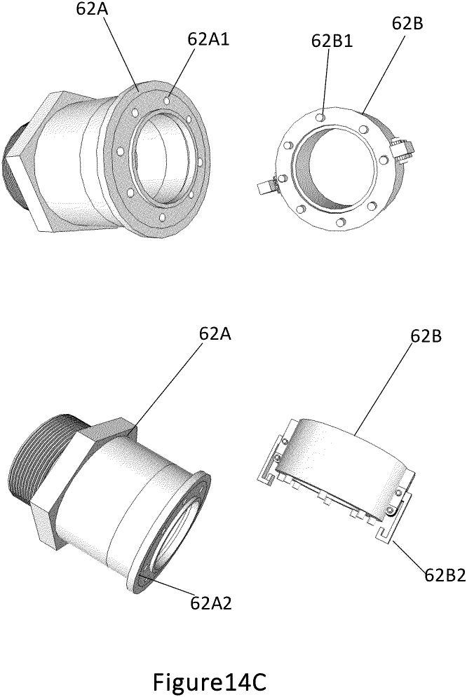

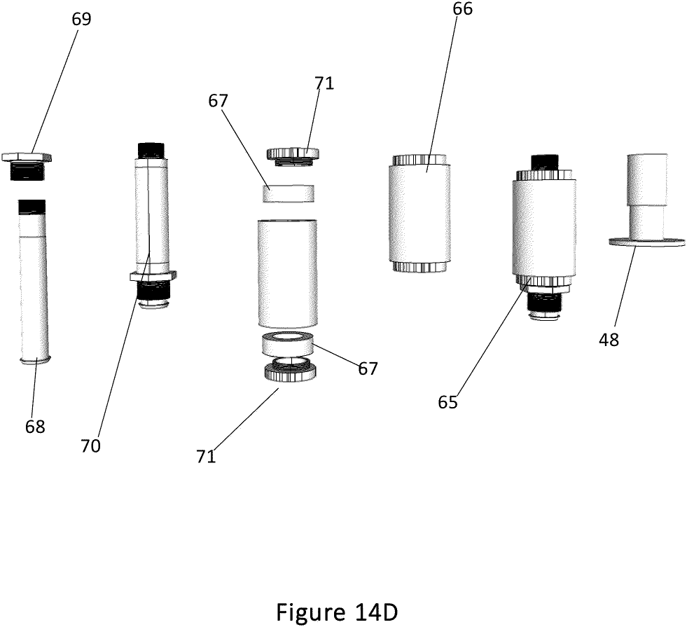

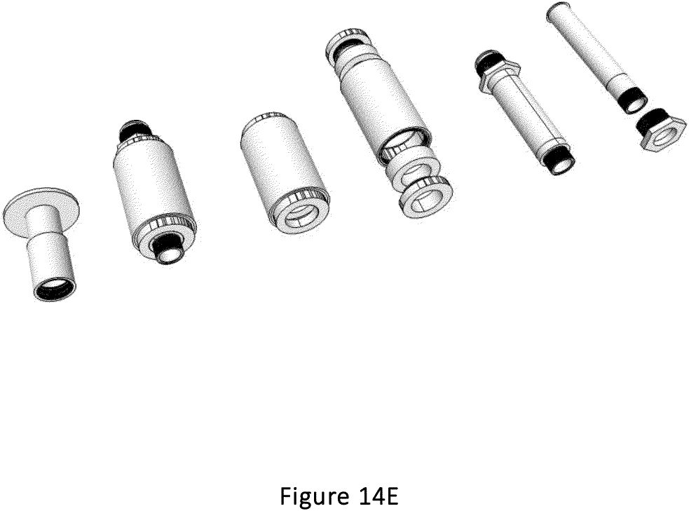

FIG. 14A is a top view of 61, 90 degree angle tube with Omni directional rotating nozzle 20. Shown at nozzle connecting, 63 female treaded coupling attachment, that connects to nozzle male tube. On the inlet side of 61 connected depicts 62B male latching attachment connected to 62A rotating attachment that attaches to 48 tube retainer cap assemble.

FIG. 14B is a front view of the Omni directional rotating nozzle depicting front water ports. The side tube water ports are angled to initiate rotate of nozzle with inertia from water flow which will increase oscillation of nozzle when water pressure is increased.

FIG. 14C is a view of the rotating 360 degree connector parts for the 90 degree tube rotation with multiple views of 62A and 62B. 62A, depicts 62A1 port slot that’s receives 62B1 insert pins to lock 90 degree curve nozzle attachment in desired point when rotating 360 degrees clockwise or counterclockwise. 62B2, toggle latch, latches on to 62A2 lip hasp to keep 62A, 62B from separating and secures tight fit to prevent water leakage.

FIG. 14D is a top view of Omni directional rotating nozzle parts which in sequence are in order of assemble starting with, 69 inner tube sleeve collar that slide to the lip end of inner tube 68 to attach full assemble 65, to 48 retainer cap assemble. Outer tube assemble casing 66 are inserted at each end with 67, bearings and which are lock in place with 71, bearing fasteners. Parts 68, 69, are inserted into 70. delrin tube sleeve which is inserted into the assemble of 67,71,66 which comprises the full assemble of 65. The threaded end of 65, connects to the nozzle head as depicted in 14A, 20.

FIG. 14E is a perspective view of nozzle parts in sequence order of assemble from right to left.

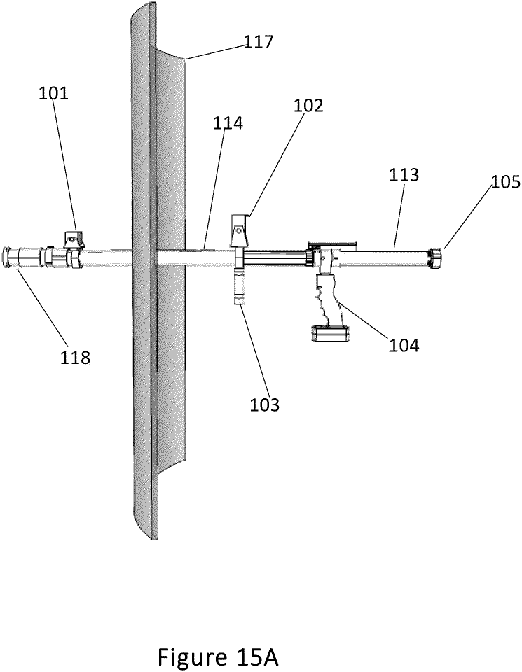

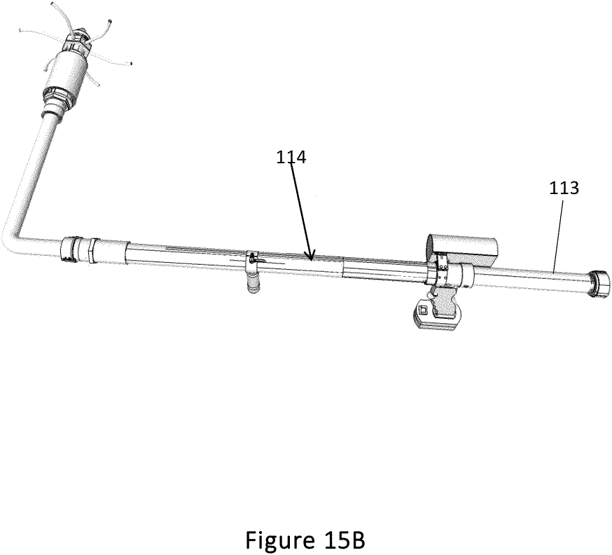

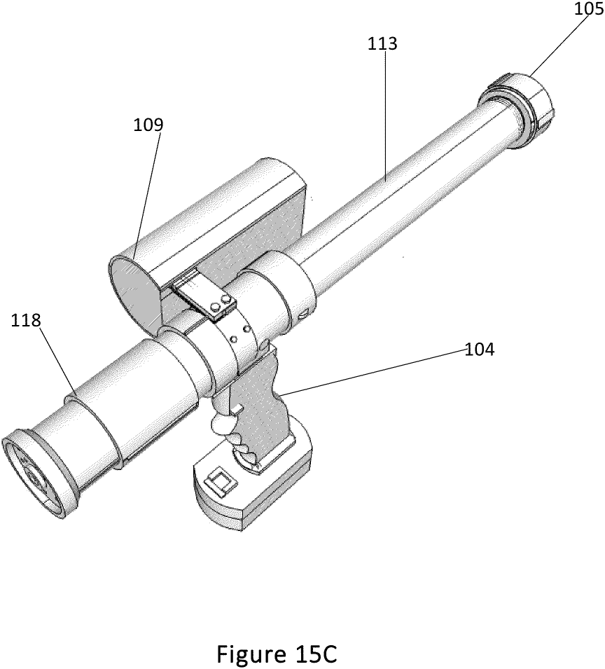

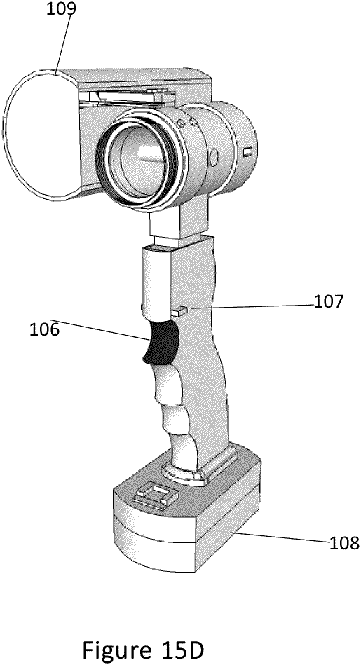

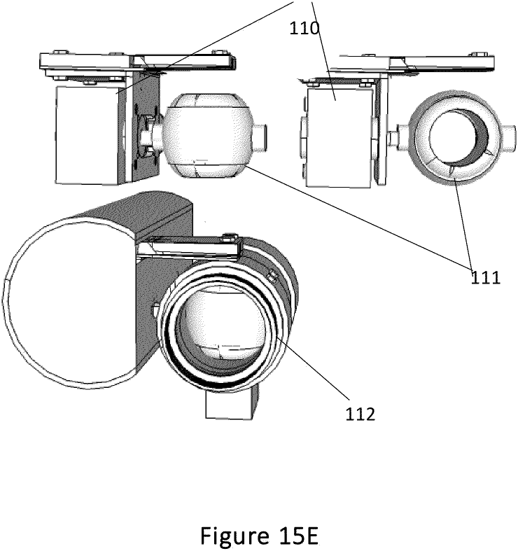

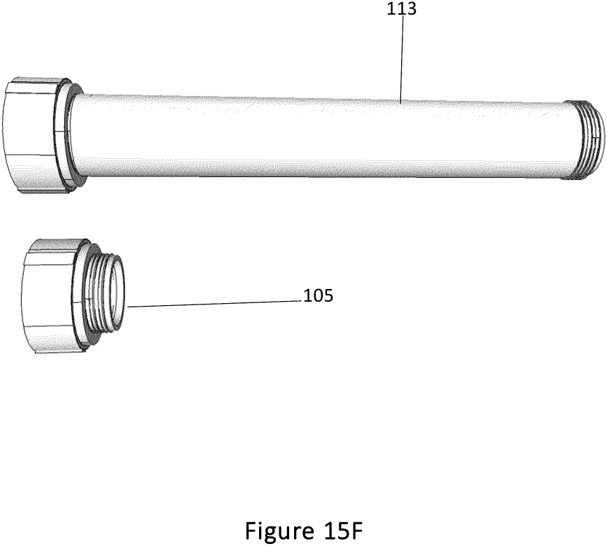

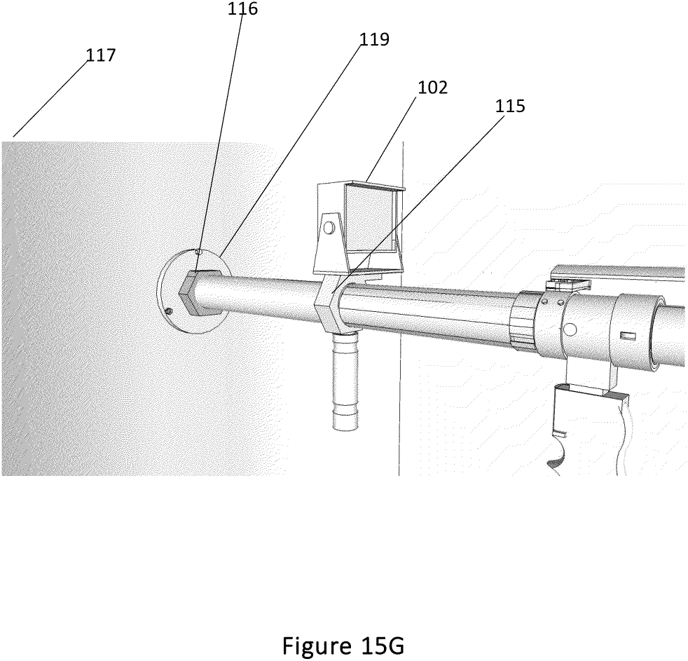

FIG. 15A is a side view of the automated water gun nozzle depicting, 114 inline extended tube, 118, off the shelf forestry nozzle attached. Also displays attachments, 101 IR camera, with tension adjustment to move up and down tube for desires positioning. 103 front nozzle tube handle attachment with tension adjustment to move up and down tube for desires positioning, which also has 102 video monitor attached on top end. Incorporated between,114104, nozzle DC powered control handle and 113 nozzle rear tube attachment, incorporated with, 105 hose adapter. Polycarbonate shield 117 is attached to 114 inline extended tube with tension adjustment bracket figure, 15G, 116 to move up and down tube for desires positioning.

FIG. 15B is a top angle view of the automated water gun with extended tube connected to 90 degree angle tube.

FIG. 15C is a perspective view of automated water gun nozzle with, 118 off the shelf forestry nozzle attached in the industry standard positioning not extended.

FIG. 15D is a front angle view of automated water gun nozzle control that depicts, 108 rechargeable battery, 106 throttle trigger that sends power to the gear motor housed in, 109 shown in FIG. 15E, 110 valve rotation gear motor to open and close water valve, 111. Also depicted, 107 gear motor directional switch.

FIG. 15E is a front view of the automated water gun nozzle components which displays, 110 valve rotation gear motor, 111 open and close valve and, 112 tube housing for valve.

FIG. 15F is a side view of the automated water gun rear tube and hose adapter.

FIG. 15G is a perspective view of the automated water gun front tube, 117 attached to 119 shield plate, attached to, 116 tension adjustment bracket to move up and down tube for desired positioning. Also depicts, 115 front tube handle bracket and, 102 camera monitor.

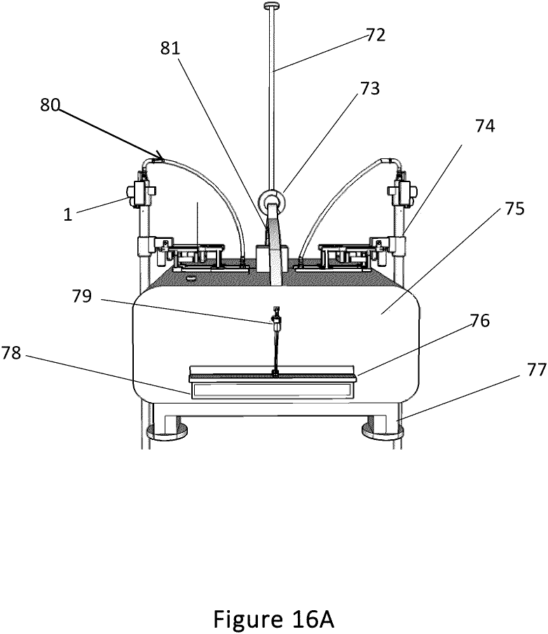

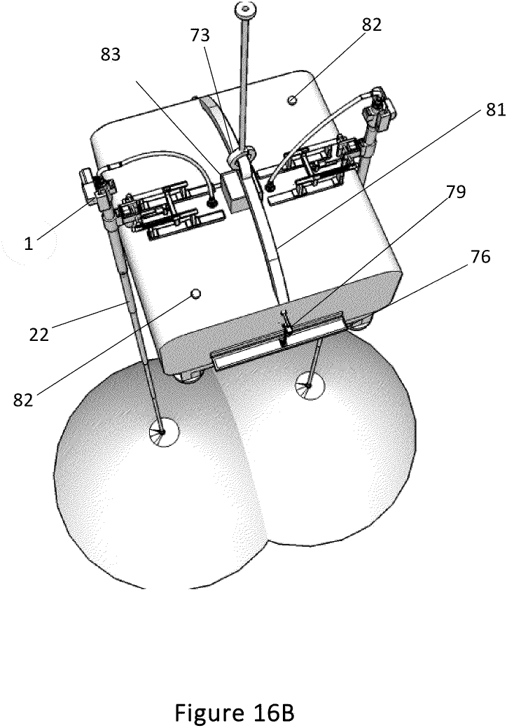

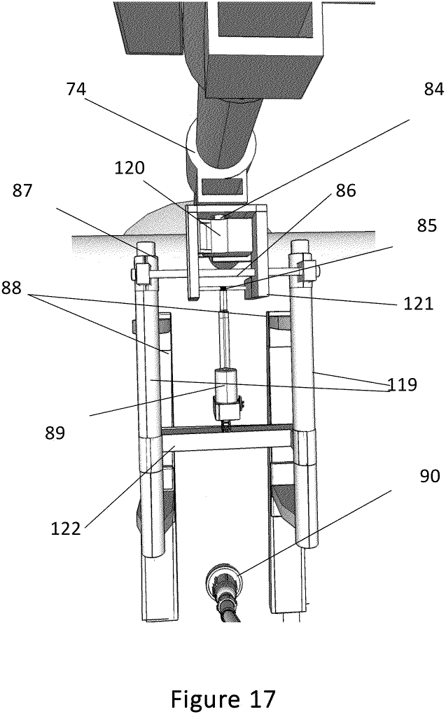

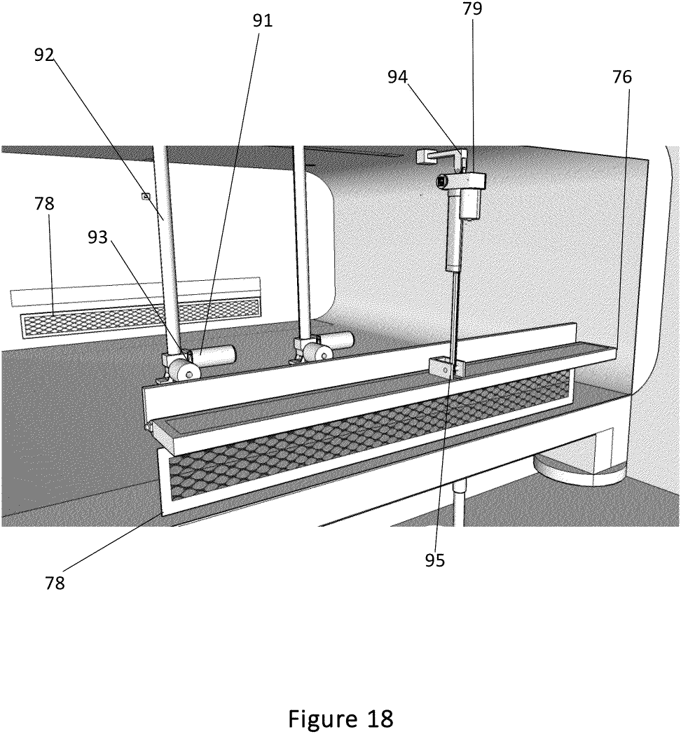

FIG. 16A is a front view of air lift water tanker that depicts the majority of the components starting with, 72 water tanker lifting cable that has, 73 lifting ring attached which loops and fastens to, 81 water tanker lifting bar for transporting apparatus for refill and area of fire mission. The water tanker body, 75 is to carry the water for distribution which has to four points of filling. The first two are, 76 water inlet doors which are located at front and rear of water tank and are incorporated with, 78 screen ports of entry that prevent large debris and trash from entering water tank that may clog or damage pumps. Water inlet door actuators, 79 open the doors to let water in when tanks are submerge for filling and close when tanks are full. There are two supply hoses, 80 that feed water to two telescopic water cannons from two water pumps that are depicted in FIG. 18 water pumps and assembles. The telescoping water cannons are secure and held in place by, 74 telescoping tube control bracket sleeve assemble that’s connected to FIG. 17 support base platform assembly. Too balance and support the weight of the water tank are four large base legs, 77.

FIG. 16B is a top perspective view of the air water tanker that depicts, 82 2 water inlet ports than are capped, and are used to fill tank with hose from water source. Remote control receiver box, 83 is incorporated with, battery, distribution panel and control unit with receiver antenna. Remote transmission from helicopter or other air transport craft will control telescopic water cannon via joy stick and video monitoring system.

FIG. 17 is a top view of the telescoping water cannon support platform rotation assemble attached to the water tanker. The assemble support, 88 is attached to the water tanker, with 87 support brackets attached to support tubes 119 for axis rotation of telescopic water cannon. This is accomplish by, 86 rotation support bar slotted into 87 support brackets for rotation support when, 89 rotation control actuator connect to, 122 the base support receives commands via remote to extend or retract to rotate 121 right angle bracket gear motor assemble in and out. The brake motor assemble is incorporated with, 120 right angle brake motor with, 84 shaft coupling that connected to, 74 telescoping tube control bracket sleeve assemble. When commands are sent to, 120 right angle brake gear motor it will rotate the automated telescopic water gun clockwise and counter clockwise and hold in position with its magnetic brake.

FIG. 18 is a front internal view of the inlet port assemble and water pumps that depicts the two parts not mentioned in other figures which are, 94 port door actuator rear bracket and, 95 port door rotation fastener bracket.

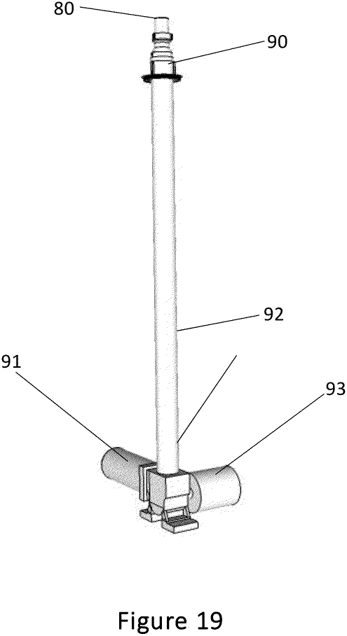

FIG. 19 is a front view of submersible water pump assemble which depicts, 91 water pump motor which sucks water through, 93 screened water inlet portal. The water passes through system and exits upward to, 92 exit tubes to, 90 water hose connector suppling water to the telescopic water cannon.

The embodiments of the invention in which an exclusive property or privilege is claimed are defined as follows:

1. Apparatuses that’s are to fight fires with automated control water cannon having telescoping capabilities that travel on a bipod wheel assemble that has optional self-propelled wheel drive throttle control, automated water gun, and airborne water tanker remote controlled with telescoping water cannons.

2. I Claim an automated telescoping water cannon with tubes that extend with water pressure.

3. I Claim an automated telescoping water cannon with telescoping tubes that retract, hold in position with hoist spool brake system.

4. I Claim an automated telescoping water cannon with hoist spool that blocks water from back flowing into spool with backflow preventer assemble.

5. I Claim an automated telescoping water cannon retainer cap assemble that hold and retract tubes to nesting position when host spool is reversed with rocker switch.

6. I Claim an automated telescoping water cannon telescoping water cannon with Polycarbonate shield attached to outer tube with adjustable positioning sleeve clamp.

7. I Claim an automated telescoping water cannon water inlet valve controlled with waterproof linear actuator or waterproof gear motor when activated with rocker switch.

8. I Claim an automated telescoping water cannon with bipod that elevates, lowers, extends and retracts with waterproof linear actuators when activated with rocker switches.

9. I Claim an automated telescoping water cannon with bipod locking bar, with rod inserted controlled with cable pull locking handle.

10. I Claim an automated telescoping water cannon with mode of travel as to, self-propelled wheels system with throttle controlled.

11. I Claim an automated telescoping water cannon with rear support leg with locking wheel.

12. I Claim an automated telescoping water cannon system powered with rechargeable DC battery.

13. I Claim an tube attachment for the automated telescoping water cannon and automated water gun with 90 degree bend, rotating 360 degrees with pin locking latching assemble.

14. I Claim an automated water gun with extended tube in front and rear with polycarbonate shield attached as stated in claim 6 of telescoping water cannon.

15. I Claim an automated water gun with water inlet value controlled with gear motor, variable speed pressure directional locking trigger incorporated in pistol grip handle.

16. I Claim an automated water gun powered with DC battery as stated in claim 11, with battery incorporated in pistol grip handle base.

17. I Claim an automated water gun with infrared camera and video monitor with multiple axis rotation, adjustable positioning sleeve clamps as stated in claim 6.

18. I Claim an remote controlled airborne water tanker with telescoping water cannons as stated in claim 1 attached to rotating bracket assemble with waterproof right angle brake gear motors, waterproof linear actuators in support frames with water supplied by two internal water pumps.

19. I Claim an remote controlled airborne water tanker with two inlet water ports that close and open with waterproof linear actuators with operating components controlled by receiver control box via remote.

20. I Claim an Omni direction rotating nozzle that spins at a high rate of speed from water pressure flowing through and exiting multiple angle tubes creating inertia force.
